(19) United States
(12) Patent Application Publication
(10) Pub. No.: US 2004/0014857 A1
(43) Pub. Date: Jan. 22, 2004

(54) Silane-containing polyvinyl alcohol for coating slips

(75) Inventors: Andreas Bacher, Burghausen (DE); Karl-Ernst Fickert, Altoetting (DE); Theo Mayer, Julbach (DE); Kurt Stark, Burgkirchen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Polymer Systems GmbH & Co. KG, Burghausen (DE)

(21) Appl. No.: 10/618,936

(22) Filed: Jul. 14, 2003

(30) Foreign Application Priority Data
Jul. 18, 2002 (DE) 102 32 666.5

(51) Int. Cl. C08K 5/24

(52) U.S. Cl. 524/261

(57) ABSTRACT

Silane-containing polyvinyl alcohols, useful as additives in coating slips, are based on completely hydrolyzed or partially hydrolyzed vinyl ester copolymers having a degree of hydrolysis of from 75 to 100 mol %, obtainable by free radical polymerization of

a) one or more vinyl esters of straight-chain or branched alkane carboxylic acids having 1 to 18 carbon atoms, of which an amount of from 1 to 30 mol %, based on total polymer, are one or more 1-alkylvinyl esters of carboxylic acids having 1 to 6 carbon atoms, and wherein the alkyl radicals have 1 to 6 carbon atoms,

b) from 0.01 to 10 mol % of one or more silane-containing, ethylenically unsaturated monomers and, if required,

c) further comonomers copolymerizable therewith,

and hydrolysis of the polymers obtained thereby.

### BACKGROUND OF THE INVENTION

1. Field of the Invention

The invention relates to silane-containing polyvinyl alcohols useful for coating slips, in particular for coating inkjet recording materials, and to coating slips prepared therewith.

2. Background Art

Polyvinyl alcohols are used as cobinders in paper coating slips in order to improve the gloss and the brightness of the paper coating. The paper coats, in particular for inkjet papers, are exposed to a high mechanical load. It is therefore necessary for the coatings to be distinguished by high abrasion resistance. Moreover, the formulation must ensure good ink absorption without the ink drop running.

EP-A 76940 describes silicon-containing polyvinyl alcohols which are used for paper coating. The silicon content is introduced either by subsequent silylation of polyvinyl alcohol or by means of copolymerization of ethylenically unsaturated, silane-containing comonomers with vinyl monomers and subsequent hydrolysis of the vinyl ester units.

EP-A 1127706 discloses paper coatings which are distinguished by high water resistance, light stability and heat stability and are therefore very suitable for use outdoors. This property profile is obtained by a combination of pigment, silanol-modified polyvinyl alcohol, and a film-forming polymer having a Tg<50° C.

Heat-sensitive recording papers having a coating which contains silicon compounds are disclosed in DE-C 3519575. The silicon compounds may be silicon-modified polyvinyl alcohols in combination with colloidal silica and/or amorphous silica.

EP-A 1080940 relates to a coating composition for the production of heat-sensitive recording materials or inkjet papers which contain ethylene/vinyl alcohol copolymers, silicon-modified vinyl alcohol polymers, or silicon-modified ethylene/vinyl alcohol polymers as one component, and an organotitanium compound as a further component.

It would be desirable to provide an additive for coating slips, in particular for the production of coatings on inkjet recording materials, which provides high abrasion resistance both on paper substrate materials and on plastics substrate materials, without adversely affecting other properties of the coating.

### SUMMARY OF THE INVENTION

It has now been surprisingly discovered that coating slips for paper and other substrates which exhibits excellent abrasion resistance while retaining other desirable properties of coating slips may be prepared using copolymeric polyvinyl ester polymers prepared from vinyl ester monomers including 1-30 mol % of C₁₋₆ 1-alkylvinyl esters of C₁₋₆ carboxylic acids and 0.01 to 10 mol % of ethylenically unsaturated silane monomers.

### DETAILED DESCRIPTION OF THE PREFERRED EMBODIMENT(S)

The invention relates to silane-containing polyvinyl alcohols and their use as additives in coating slips. The silane-containing polyvinyl alcohols are based on completely hydrolyzed or partly hydrolyzed vinyl ester copolymers having a degree of hydrolysis of from 75 to 100 mol %, obtained by free radical polymerization of a) one or more vinyl esters of straight-chain or branched alkane carboxylic acids having 1 to 18 carbon atoms, of which an amount of from 1 to 30 mol %, based on total polymer, are one or more 1-alkylvinyl esters wherein the esterifying carboxylic acid is a C₁₋₆ carboxylic acid, and the 1-alkyl radicals are C₁₋₆ alkyl radicals; b) from 0.01 to 10 mol % of one or more silane-containing, ethylenically unsaturated monomers, and optionally, c) further comonomers copolymerizable therewith, followed by hydrolysis of the polymers obtained thereby.

Suitable silane-containing polyvinyl alcohols are completely hydrolyzed or partly hydrolyzed vinyl ester polymers having a degree of hydrolysis of from 75 to 100 mol % and a content of silane-containing comonomer units of from 0.01 to 10 mol %. The completely hydrolyzed vinyl ester polymers have a degree of hydrolysis of, preferably, from 97.5 to 100 mol %, more preferably from 98 to 99.5 mol %. The partly hydrolyzed polyvinyl esters preferably have a degree of hydrolysis of from 80 to 95 mol %, more preferably from 86 to 90 mol %. The Höppler viscosity (4% by weight aqueous solution according to DIN 53015) serves as a measure of the molecular weight and of the degree of polymerization of the partly or completely hydrolyzed, silanized vinyl ester polymers, and is preferably from 2 to 50 mPas.

Suitable vinyl esters are vinyl esters of straight-chain or branched carboxylic acids having 1 to 18 C atoms. Preferred vinyl esters are vinyl acetate, vinyl propionate, vinyl butyrate, vinyl 2-ethylhexanoate, vinyl laurate, vinyl pivalate and vinyl esters of α-branched monocarboxylic acids having 5 to 13 C atoms, for example VeoVa® 9 or VeoVa® 10 (trademarks of Resolution Performance Products). Vinyl acetate is particularly preferred.

Preferred 1-alkylvinyl esters having C₁₋₆ alkyl radicals, and which are esters of C₁₋₆ carboxylic acids, are 1-methylvinyl acetate, 1-ethylvinyl acetate and 1-propylvinyl acetate.

In addition to the vinyl ester units, one or more monomers c) from the group consisting of methacrylates and acrylates of C₁₋₁₅ alcohols, olefins, dienes, vinylaromatics and vinyl halides can optionally be copolymerized. Suitable (meth)acrylic acid ester monomers include esters of straight-chain or branched (“optionally branched”) C₁₋₁₅ alcohols. Preferred (meth)acrylates are methyl acrylate, methyl methacrylate, ethyl acrylate, ethyl methacrylate, propyl acrylate, propyl methacrylate, n-butyl acrylate, isobutyl acrylate, tert-butyl acrylate, n-butyl methacrylate, isobutyl methacrylate, tert-butyl methacrylate, 2-ethylhexyl acrylate and norbornyl acrylate. Methyl acrylate, methyl methacrylate, n-butyl acrylate, isobutyl acrylate, tert-butyl acrylate, 2-ethylhexyl acrylate and norbornyl acrylate are particularly preferred. Suitable dienes include 1,3-butadiene and isoprene. Examples of polymerizable olefins include ethene and propene. As vinylaromatics, styrene and vinyltoluene are preferably incorporated as polymerized units. From the vinyl halides, vinyl chloride, vinylidene chloride and vinyl fluoride, preferably vinyl chloride, are preferably used. The proportion of these comonomers is such that the proportion of vinyl ester monomer is >50 mol % in the vinyl ester polymer.

If required, further comonomers c), preferably in a proportion of from 0.1 to 25 mol % may also be present. Examples of these are ethylenically unsaturated mono- and dicarboxylic acids, preferably acrylic acid, methacrylic acid, fumaric acid and maleic acid; ethylenically unsaturated carboxamides and carbonitriles, preferably N-vinylformamide, acrylamide and acrylonitrile; mono-and diesters of fumaric acid and maleic acid such as the diethyl and diisopropyl esters; maleic anhydride; and ethylenically unsaturated sulfonic acids and salts thereof, preferably vinylsulfonic acid and 2-acrylamido-2-methylpropanesulfonic acid. Further examples are precrosslinking comonomers such as polyethylenically unsaturated comonomers, for example divinyl adipate, diallyl maleate, allyl methacrylate, butanediol diacrylate, and triallyl cyanurate, and postcrosslinking comonomers, for example acrylamidoglycolic acid (AGA), methyl methylacrylamidoglycolate (MAGME), N-methylolacrylamide (NMA), N-methylolmethacrylamide, N-methylolallylcarbamate, alkyl ethers or esters of N-methylolacrylamide, of N-methylolmethacrylamide and of N-methylolallylcarbamate, such as their isobutoxy ethers or esters.

Suitable ethylenically unsaturated, silane-containing monomers b) are, for example, ethylenically unsaturated silicon compounds of the general formula R¹SiR²₀₋₂(OR³)₁₋₃, in which R¹ independently are CH₂═CR⁴—(CH₂)₀₋₃ or CH₂═CR⁴CO₂(CH₂)₁₋₃, each R² independently is a C₁- to C₃-alkyl radical, C₁- to C₃-alkoxy radical or halogen, preferably Cl or Br, each R³ is independently a straight-chain or branched, unsubstituted or substituted C₁₋₁₂ alkyl radical, preferably a C₁₋₃ alkyl radical, or is a C₂₋₁₂ acyl radical, it being possible for R³ to be interrupted by an ether group, and each R⁴ independently is H or CH₃.

Suitable ethylenically unsaturated, silane-containing monomers b) are also (meth)acrylamides which contain silane groups, for example those of the general formula CH₂═CR⁵—CO—NR⁶—R⁷—SiR⁸ₘ—(R⁹)₃₋ₘ, in which m=0 to 2, each R⁵ is independently either H or a methyl group, each R⁶ is independently H or an alkyl group having 1 to 5 C atoms; each R⁷ is independently a C₁₋₅ alkylene group or a bivalent organic group in which the carbon chain is interrupted by an O or N atom, each R⁸ is independently a C₁₋₅ alkyl group, and each R⁹ is independently a C₁₋₄₀ alkoxy group which may be substituted by further heterocycles, preferably O, N, S, or P. In monomers in which 2 or more R⁵ or R⁹ groups occur, these may be identical or different.

Examples of such (meth)acrylamidoalkylsilanes are: 3-(meth)acrylamidopropyltrimethoxysilanes, 3-(meth)acrylamido-propyltriethoxysilanes, 3-(meth)acrylamidopropyltri(β-methoxyethoxy)silanes, 2-(meth)acrylamido-2-methylpropyltrimethoxysilanes, 2-(meth)acrylamido-2-methyl-ethyltrimethoxysilanes, N-(2-(meth)acrylamidoethyl)aminopropyltrimethoxysilanes, 3-(meth)acrylamidopropyltriacetoxysilanes, 2-(meth)acrylamido-ethyltrimethoxysilanes, 1-(meth)acrylamidomethyltrimethoxysilanes, 3-(meth)acrylamidopropylmethyldimethoxysilanes, 3-(meth)acrylamidopropyl-dimethylmethoxysilanes, 3-(N-methyl-(meth)acrylamido)propyltrimethoxysilanes, 3-((meth)acrylamido-methoxy)-3-hydroxypropyltrimethoxysilanes, 3-((meth)acrylamidomethoxy)propyltrimethoxysilanes, N,N-dimethyl-N-trimethoxysilylpropyl-3-(meth)acrylamido-propylammonium chloride and N,N-dimethyl-N-trimethoxysilylpropyl-2-(meth)acrylamido-2-methylpropylammonium chloride.

Preferred ethylenically unsaturated, silane-containing monomers b) are γ-acryloyl- or γ-methacryloyloxypropyltri(alkoxy)silanes, α-methacryloyloxymethyltri(alkoxy)silanes, γ-methacryloyloxypropyl-methyldi(alkoxy)silanes; vinylsilanes such as vinylalkyldi(alkoxy)silanes and vinyltri(alkoxy)silanes, the alkoxy groups of which may be for example, methoxy, ethoxy, methoxyethylene, ethoxyethylene, methoxypropylene glycol ether or ethoxypropylene glycol ether radicals. Examples of preferred silane-containing monomers are 3-methacryloyloxypropyltrimethoxysilane, 3-methacryloyloxypropylmethyldimethoxysilane, vinyltrimethoxysilane, vinylmethyldimethoxysilane, vinyltriethoxysilane, vinylmethyldiethoxysilane, vinyltripropoxysilane, vinyltriisopropoxysilane, vinyltris(1-methoxy)isopropoxysilane, vinyltributoxysilane, vinyltriacetoxysilane, methacryloyloxymethyltrimethoxysilane, 3-methacryloyloxypropyltris(2-methoxyethoxy)silane, vinyltrichlorosilane, vinylmethyldichlorosilane, vinyltris(2-methoxyethoxy)silane, trisacetoxyvinylsilane, allylvinyltrimethoxysilane, allyltriacetoxysilane, vinyldimethylmethoxysilane, vinyldimethylethoxysilane, vinylmethyldiacetoxysilane, vinyldimethylacetoxysilane, vinylisobutyldimethoxysilane, vinyltriisopropoxysilane, vinyltributoxysilane, vinyltrihexyloxysilane, vinylmethoxydihexyloxysilane, vinyltrioctyloxysilane, vinyldimethoxyoctyloxysilane, vinylmethoxydioctyloxysilane, vinylmethoxydilauryloxysilane, vinyldimethoxylauryloxysilane and also polyethylene glycol-modified vinylsilanes.

Preferred silanes b) are in general vinyltrimethoxysilane, vinylmethyldimethoxysilane, vinyltriethoxysilane, vinylmethyldiethoxysilane, vinyltris(1-methoxy)isopropoxysilane, methacryl-oyloxypropyltris(2-methoxyethoxy)silane, 3-methacryloyloxy-propyltrimethoxysilane, 3-methacryloyloxypropylmethyldimethoxysilane and methacryloyloxymethyltrimethoxysilane and mixtures thereof.

The ethylenically unsaturated, silane-containing monomers b) are copolymerized in amounts of from 0.01 to 10.0 mol %, preferably from 0.01 to 1.0 mol %.

The vinyl ester polymers can be prepared in a known manner by means of polymerization; preferably by mass polymerization, suspension polymerization or polymerization in organic solvents, most preferably in organic solution. Suitable solvents are, for example, methanol, ethanol, propanol and isopropanol. The polymerization is carried out under reflux at a temperature of from 55° C. to 100° C. and is initiated by means of free radicals by adding customary initiators. Examples of customary initiators are percarbonates such as cyclohexyl peroxydicarbonate, or peresters such as tert-butyl perneodecanoate or tert-butyl perpivalate.

The monomers can be initially introduced all together, metered in all together, or initially introduced in portions and the remainder metered in after initiation of the polymerization. The metering operations can be carried out separately (with respect to space and time) or some or all of the components to be metered can be metered in preemulsified form.

The molecular weight can be established in a manner known to a person skilled in the art by polymerization in the presence of molecular weight regulators (“chain transfer agents”). Suitable regulators are, for example, alcohols such as ethanol or isopropanol, aldehydes such as acetaldehyde or propionaldehyde, and silane-containing regulators such as mercaptosilanes, for example 3-mercaptopropyltrimethoxysilane.

The hydrolysis of the vinyl ester polymers is effected in a manner known per se, for example by the belt or kneader method or in a stirred vessel, in the alkaline or acidic range with addition of acid or base. Preferably, the solid vinyl ester resin is taken up in alcohol, for example methanol, a solids content of from 15 to 70% by weight being established. The hydrolysis is preferably carried out in the basic range, for example by adding NaOH, KOH or NaOCH₃. The base is generally used in an amount of from 1 to 5 mol % per mole of ester units. The hydrolysis is carried out at temperatures of from 30° C. to 70° C.

After the hydrolysis is complete, the solvent is distilled off and the polyvinyl alcohol is obtained as a powder. However, the polyvinyl alcohol can also be obtained as aqueous solution by gradual addition of water while the solvent is being distilled off. The aqueous solution of the silane-containing polyvinyl alcohols can, if required, be spray-dried, and the silane-containing polyvinyl alcohol obtained as a powder.

The silane-containing polyvinyl alcohols are suitable, optionally in combination with further binders and additives, as additives in formulations of coating slips for the coating of substrate materials, preferably substrates comprising paper or plastics film, in particular for inkjet recording materials, for example inkjet paper and inkjet foils. Example of suitable substrate materials are paper, plastic-coated paper, such as polyethylene-, polypropylene- or PET-coated paper, and cellulose acetate foils, polyester foils such as PET foil, polyamide, polycarbonate, polyolefin, polyimide, polyamide, polyvinyl acetal, polyether and polysulphonamide foils.

The formulations for coating slips are known to a person skilled in the art. In general, from 10 to 50% by weight of the silane-containing polyvinyl alcohols (solid), based on the total solids content of the formulation, are used. The silane-containing polyvinyl alcohols can be used as sole binders or as cobinders with further binders.

Typical further additives and binders include:

Cationic dispersants such as polydiallyldimethylammonium chloride, benzyldimethylstearylammonium chloride, dimethylstearylammonium chloride, copolymers with acrylamide, dimethylamino epichlorohydrin, polyoxyalkylpolyaminodicyanodiamine, dimethylaminoethyl methacrylate (MADAME)-modified polymers, methacryloyloxyethyltrimethylammonium chloride (MADQUAT)-modified polymers, cationic cellulose derivatives, cationic starch derivatives, cationic polyvinyl alcohols, polyethylenimine and its copolymers, compounds having trivalent aluminium, boron and zinc ions, triethanolamine-titanium chelate complex, copolymers of vinylpyrrolidone, and polyamidoamines;

Binders such as hydroxyethylcellulose, starch, gelatin, casein, polyvinylpyrrolidones, dextran, dextrin, polyethylene glycols, agar, carrageenan, xanthan, polymer dispersions, such as styrene/butadiene latices, polyacrylate emulsions, polyvinyl ester dispersions;

Plasticizers such as ethylene glycol, diethylene glycol, propylene glycol, polyethylene glycol, glycerol, glyceryl monomethyl ether, glyceryl monochlorohydrin, ethylene carbonate, propylene carbonate, tetrachlorophthalic anhydride, tetrabromophthalic anhydride, urea, urea phosphate, triphenyl phosphate, glyceryl monostearate, propylene glycol monostearate, tetramethylene sulphone, N-methyl-2-pyrrolidone, N-vinyl-2-pyrrolidone, and sorbitol;

Pigments and fillers such as silica, calcium carbonate, clay, bentonite, alumina and titanium oxide;

Antifoams and dispersants, such as polydiallyldimethylammonium chloride, benzyldimethylstearylammonium chloride and dimethylstearylammonium chloride; and leveling agents, tinting dyes, wetting agents, viscosity stabilizers, pH regulators, curing agents, UV absorbers, antioxidants, optical brighteners, and dye-fixing agents.

The silane-containing polyvinyl alcohols give coatings which are distinguished by excellent abrasion resistance. Furthermore, ease of production of binders containing the silane-containing polyvinyl alcohols is facilitated by the excellent storage stability of solutions of the latter.

### EXAMPLES

### Example 1

612 g of water, 61.2 mg of copper(II) acetate and 61.2 g of a 5% by weight polyvinylpyrrolidone solution (PVD-K90) in water were initially introduced under nitrogen into a thermostated laboratory apparatus having a capacity of 2.5 liters. A solution of 620 mg of tert-butyl per-2-ethylhexanoate (TBPEH 99% strength in water), 322 mg of tert-butyl perneodecanoate (Pergan PND 95% strength in water), 4.9 g of vinyltriethoxysilane, 48.9 g of isopropenyl acetate and 42.8 g of isopropanol in 612 g of vinyl acetate were run in while stirring. The reactor was heated to 51.5° C. and, after the reaction had diminished, was heated stepwise to 75° C. This temperature was maintained for a further 2 hours, after which the reaction mixture was cooled. The resulting polymer beads were filtered off with suction, washed thoroughly with water and dried.

In a laboratory reactor having a capacity of 2.5 liters, 90 g of polymer beads were dissolved in 810 g of methanol at 50° C. The solution was cooled to 30° C., a layer of 500 g of methanol was introduced on top with the stirrer stationary, and the methanolic NaOH was immediately added (10 g of NaOH, 46% by weight in water, dissolved in 90 g of methanol) and the stirrer was switched on.

The solution became increasingly turbid. During the gel phase, the stirrer was set to a higher speed in order to comminute the gel. After the gel phase, the reaction was allowed to continue for a further 2 hours, neutralization was effected with acetic acid and the solid product was filtered off, washed and dried. A completely hydrolyzed polyvinyl alcohol having a Höppler viscosity of 28 mPas (4% by weight in water) was obtained.

### Comparative Example 1

Commercial silane-containing polyvinyl alcohol having a Höppler viscosity of 25 mPas (4% by weight in water).

Testing of Performance Characteristics:

The polyvinyl alcohols from the example and comparative example were tested in the following formulations:

Formulation of Coating Slip for Paper Coating:

| | |
|---|---|
| Precipitated silica | 100 parts by weight |
| Polyvinyl alcohol | 35 parts by weight |
| Cationic dispersant | 5 parts by weight |
| Solids content of the coating slip: | 20-35% by weight |

The coating slip was tested on base paper: sized paper, 80 g/m². The coat was 15 g/m².

Formulation for Coating Slip for Coating Plastics Foils:

| | |
|---|---|
| Precipitated silica | 100 parts by weight |
| Polyvinyl alcohol | 34 parts by weight |
| Cationic dispersant | 8 parts by weight |
| Polymer dispersion | 50 parts by weight |
| Solids content of the coating slip: | 20-28% by weight |

The coating slip was tested on a 90 g/m² PET foil provided with an adhesion promoter. The coat was 15 g/m².

Abrasion Test:

A 4.5 cm wide and 19 cm long coated paper strip or foil strip was processed by means of 50 strokes in an abrasion tester from Prüfbau (Dr. Dürner system) with a black drawing paper applied to a stamp (500 g).

The resulting black paper was then assessed visually, the rating 1 representing the optimum.

Brightness:

The brightness was determined by means of reflectance measurement using a R 457 filter and was visually assessed, the rating 1 representing the optimum.

Storage Stability:

The storage stability was tested by storing in each case 11% strength aqueous solutions of the polyvinyl alcohols at a pH of 8.5 for up to 14 days and determining the Höppler viscosity (according to DIN 53015, as a 4% by weight aqueous solution).

TABLE 1
(Results on paper):

| Coat analysis | Example 1 | Comparative Example 1 |
|---|---|---|
| Abrasion test | 1.0 | 1.5 |
| Brightness, visual | 1.0 | 1.0 |
| Brightness, R457 | 5.1 | 5.2 |

TABLE 2
(Results on plastics foil):

| Coat analysis | Example 1 | Comparative Example 1 |
|---|---|---|
| Abrasion test | 1.0 | 1.5 |
| Brightness, visual | 1.0 | 1.0 |
| Brightness, R457 | 5.3 | 5.3 |

TABLE 3
(Shelf life):

| | Hoppler viscosity [mPas], | Hoppler viscosity [mPas], |
|---|---|---|
| Storage time | Example 1 | Comparative Example 1 |
| immediately | 28.1 | 25.1 |
| 1 day | 28.1 | 27.8 |
| 2 days | 28.1 | 31.4 |
| 3 days | 28.2 | 35.8 |
| 5 days | 28.2 | 42.9 |
| 7 days | 28.2 | 61.7 |
| 14 days | 28.3 | 90.5 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A silane-containing polyvinyl alcohol comprising a completely hydrolyzed or partially hydrolyzed vinyl ester copolymer having a degree of hydrolysis of from 75 to 100 mol %, obtained by free radical polymerization of
a) one or more vinyl esters of straight-chain or branched alkane carboxylic acids having 1 to 18 carbon atoms, of which an amount of from 1 to 30 mol %, based on total polymer, are one or more 1-alkylvinyl esters of C₁₋₆ carboxylic acids, where the 1-alkyl groups are C₁₋₆ alkyl radicals;
b) from 0.01 to 10 mol % of one or more silane-containing, ethylenically unsaturated monomers, and
c) optionally further comonomers copolymerizable therewith, and hydrolysis of the polymers obtained thereby.

2. The silane-containing polyvinyl alcohol of claim 1, wherein the vinyl ester a) comprises vinyl acetate.

3. The silane-containing polyvinyl alcohol of claim 1, wherein the 1-alkylvinyl ester comprises 1-methylvinyl acetate.

4. The silane-containing polyvinyl alcohol of claim 1, having a Höppler viscosity according to DIN 53015, as 4% by weight aqueous solution of from 2 to 50 mPas.

5. The silane-containing polyvinyl alcohol of claim 1, wherein at least one silane-containing, ethylenically unsaturated monomers is selected from the group consisting of ethylenically unsaturated silicon compounds of the general formula R¹SiR²₀₋₂(OR³)₁₋₃, in which each R¹ is independently CH₂═CR⁴—(CH₂)₀₋₁ or CH₂═CR⁴CO₂(CH₂)₁₋₃, each R² independently is a C₁- to C₃-alkyl radical, C₁- to C₃-alkoxy radical, or halogen, each R³ independently is an optionally branched, optionally substituted C₁₋₁₂ alkyl radical 12 or a C₂₋₁₂ acyl radical R₃ optionally be interrupted by an ether group, and each R⁴ is independently H or CH₃, and a (meth)acrylamide containing silane groups of the formula CH₂═CR⁵—CO—NR⁶—R⁷—SiR⁸ₘ—(R⁹)₃₋ₘ, in which m=0 to 2, each R⁵ is independently H or a methyl group, each R⁶ is independently H or a C₁₋₅ alkyl group, each R⁷ is independently a C₁₋₅ alkylene group or a bivalent organic group in which the carbon chain is interrupted by an O or N atom, each R⁸ is independently a C₁₋₅ alkyl group, and each R⁹ is independently a C₁₋₄₀ alkoxy group optionally substituted by further heterocycles.

6. The silane-containing polyvinyl alcohols of claim 1, wherein said polymerization is a mass polymerization, a suspension polymerization or a polymerization in organic solvents.

7. In a coating slip wherein a polymeric binder is employed, the improvement comprising selecting as at least one polymeric binder, a silane-containing polyvinyl alcohol of claim 1.

8. In a coating slip wherein a polymeric binder is employed, the improvement comprising selecting as at least one polymeric binder, a silane-containing polyvinyl alcohol of claim 2.

9. In a coating slip wherein a polymeric binder is employed, the improvement comprising selecting as at least one polymeric binder, a silane-containing polyvinyl alcohol of claim 3.

10. In a coating slip wherein a polymeric binder is employed, the improvement comprising selecting as at least one polymeric binder, a silane-containing polyvinyl alcohol of claim 4.

11. In a coating slip wherein a polymeric binder is employed, the improvement comprising selecting as at least one polymeric binder, a silane-containing polyvinyl alcohol of claim 5.

12. A coating slip-coated substrate, comprising a substrate and the coating slip of claim 7.

13. The coating slip-coated substrate of claim 12, wherein the substrate comprises paper, plastics-coated paper, or a plastics foil.

14. The coating slip-coated substrate of claim 12, wherein the substrate is paper.

15. The coating slip-coated substrate of claim 12, wherein said coating slip-coated substrate is suitable for use in ink jet printing.
